(19) United States
(12) Patent Application Publication
(10) Pub. No.: US 2023/0102518 A1
(43) Pub. Date: Mar. 30, 2023

(54) VEHICLE PRIORITIZATION SYSTEM AND METHOD

(71) Applicant: Transportation IP Holdings, LLC, Norwalk, CT (US)

(72) Inventor: Anthony D. Paul, Anchorage, AK (US)

(21) Appl. No.: 17/489,923

(22) Filed: Sep. 30, 2021

(51) Int. Cl. G08G 1/00; G08G 1/0968; B60W 60/00

(52) U.S. Cl. CPC G08G 1/22; G08G 1/0968; B60W 60/001

(57) ABSTRACT

A controller of a first vehicle system that moves along a first route and a method related thereto includes determining a first prioritization score of the first vehicle system moving along the first route. The first prioritization score indicates one or more characteristics of the first vehicle system. A second prioritization score of a second vehicle system moving along the first route or a second route that intersects the first route is received. The second prioritization score indicates one or more characteristics of the second vehicle system. A prioritization ranking is determined between the first vehicle system and the second vehicle system by comparing the first prioritization score of the first vehicle system with the second prioritization score of the second vehicle system. Movement of the first vehicle system is automatically controlled based on the prioritization ranking.

### BACKGROUND

### Technical Field

The subject matter described herein relates to systems and methods that control movements of vehicle systems.

### Discussion of Art

Different vehicle systems move along the same routes and/or intersecting routes. In certain instances, two or more vehicle systems may encounter each other and a priority may need to be determined to indicate which vehicle system is allowed or permitted to move first, and which vehicle system must wait. As one example of two vehicle systems moving towards each other along the same route, one of the vehicle systems (e.g., with a lower priority) may need to move to an alternative route to allow the other vehicle system (e.g., with a higher priority) to continue moving on the route. In another example of two vehicle systems moving along intersecting routes, one of the vehicle systems (e.g., with a higher priority) may be allowed to move through the intersection first, and the other vehicle system (e.g., with a lower priority) may be required to wait before being allowed to move through the intersection. In another example of two vehicle systems moving along the same route in the same direction, the trailing vehicle system may be moving at a speed that is faster than the leading vehicle system. If the leading vehicle system has a priority that is less than the trailing vehicle system, the leading vehicle system may need to move to an alternative route to allow the trailing vehicle system to move ahead of the leading vehicle system, such that the previously trailing vehicle system is the new leading vehicle system.

To determine the prioritization ranking between the different vehicles that encounter each other, an operator of a control or dispatch center may need to determine which of the vehicle systems has a greater or higher rank or priority than the other vehicle system. For example, a passenger train may be determined to have a rank or priority that is greater than a coal train, and the operator of the dispatch center may direct the coal train to change an operating setting to allow the passenger train to move first or ahead of the coal train. However, prioritization scores of different vehicle systems may change based on characteristics of the vehicle systems. For example, the age of the vehicle system, the cargo being transported, the time of travel (e.g., during rush hour or non-rush hours), historical behavior of the owner of the vehicle system (e.g., does the owner perform regular maintenance of the vehicle system or is the vehicle system behind in technological upgrades), or the like, may impact the prioritization score of a vehicle system. Additionally, the dispatch center may only determine prioritization rankings between like or similar types of vehicles, and may not include dissimilar vehicles (e.g., a rail car and an automobile) in the prioritization ranking. The similar and dissimilar vehicles, however, may move along intersecting or the same routes.

A need exists for a system and method to determine a prioritization ranking between plural different vehicles (e.g., of the same type or different types of vehicles) to indicate which vehicles have priority over the other vehicles, and an order in which vehicle systems are to move, which is different than existing systems and methods.

### BRIEF DESCRIPTION

In one or more embodiments, a method includes determining a first prioritization score of a first vehicle system moving along a first route. The first prioritization score indicates one or more characteristics of the first vehicle system. A second prioritization score of a second vehicle system moving along the first route or a second route that intersects the first route is received. The second prioritization score indicates one or more characteristics of the second vehicle system. A prioritization ranking is determined between the first vehicle system and the second vehicle system based at least in part on a comparison of the first prioritization score of the first vehicle system with the second prioritization score of the second vehicle system. Movement of the first vehicle system is automatically controlled based on the prioritization ranking.

In one or more embodiments, a controller of a first vehicle system configured to move along a first route includes one or more processors that determine a first prioritization score of the first vehicle system indicative of one or more characteristics of the first vehicle system. The processors receive a second prioritization score of a second vehicle system that moves along the first route or a second route that intersects the first route. The second prioritization score indicates one or more characteristics of the second vehicle system. The processors determine a prioritization ranking between the first vehicle system and the second vehicle system based at least in part on a comparison of the first prioritization score of the first vehicle system with the second prioritization score of the second vehicle system. The processors automatically control movement of the first vehicle system based on the prioritization ranking.

In one or more embodiments, a method includes determining a ranking between a first vehicle system and a second vehicle system based at least in part on a comparison of a first prioritization score of a first vehicle system with a second prioritization score of a second vehicle system. The first vehicle system moves along a first route and the second vehicle system moves along the first route or a second route that intersects the first route. The first prioritization score of the first vehicle system is indicative of one or more characteristics of the first vehicle system, and the second prioritization score of the second vehicle system is indicative of one or more characteristics of the second vehicle system. The ranking indicates a priority of the first vehicle system that is greater than a priority of the second vehicle system. Movement of the first vehicle system is automatically controlled based on the ranking.

### BRIEF DESCRIPTION OF THE DRAWINGS

The inventive subject matter may be understood from reading the following description of non-limiting embodiments, with reference to the attached drawings, wherein below:

FIG. 1 illustrates one example of a prioritization system including plural vehicle systems moving along a route in accordance with one embodiment;

FIG. 2 illustrates a flowchart of one example of controlling movement of a vehicle system in accordance with one embodiment;

FIG. 3 illustrates one example of a prioritization system including plural vehicle systems moving along intersecting routes in accordance with one embodiment;

FIG. 4 illustrates one example of determining a prioritization score of a vehicle system in accordance with one embodiment;

FIG. 5 illustrates one example of determining a priority ranking between different vehicle systems in accordance with one embodiment; and

FIG. 6 illustrates one example of changing a prioritization score of a vehicle system as the vehicle system moves along a route in accordance with one embodiment.

### DETAILED DESCRIPTION

Embodiments of the subject matter described herein relate to a controller of a vehicle system and method of operation. The controller may determine a prioritization score of a first vehicle system that moves along a route. In one embodiment, the prioritization score may indicate a ranking or order in which the first vehicle system is to move along the route relative to other vehicle systems moving along the same route or intersecting routes. In another embodiment, the prioritization score may indicate whether the first vehicle system is permitted or allowed to move along a portion of the route. For example, the first vehicle system may be allowed to move along a first portion of the route (e.g., a portion that is less dense with vehicle and/or pedestrian traffic) and the first vehicle system may be prohibited from moving along a different, second portion of the route (e.g., a portion that is more dense with vehicle and/or pedestrian traffic, that includes a larger number of intersections relative to the first portion, or the like) based on the prioritization score of the first vehicle system. While the terms “first,” “second,” and so on, are used herein to indicate different vehicle systems, usage of the term “first” to identify a vehicle system from among several vehicle systems does not mean that the identified vehicle system will always be the first to move (or that the “second” vehicle system will always be the second to move). Instead, unless explicitly stated otherwise, the terms “first,” “second,” and so on, are only used to identify the vehicle systems.

The controller of the first vehicle system may determine and/or calculate the prioritization score of the first vehicle system. Alternatively, a controller that is off-board the vehicle systems may determine the prioritization scores. The prioritization score may be based on one or more factors including, but not limited to, conditions or characteristics of the first vehicle system, the owner of the first vehicle system, a shipper requesting shipment or movement of the first vehicle system, a type of cargo the first vehicle system is carrying, historical data related to the first vehicle system, historical data related to the owner, historical data related the shipping requesting representative, or the like.

In one or more embodiments, the conditions or characteristics of the first vehicle system may be used to determine a vehicle or asset score. The characteristics may be and/or include an age of the vehicle system, or an age of systems onboard the vehicle system (e.g., a braking system, propulsion system, or the like), a maintenance schedule of the vehicle system, whether the vehicle system has caused network delays and/or disruptions (e.g., accident reports), or the like. The owner score may be based on whether the operator or owner has caused network disruptions or delays (e.g., with the first vehicle system or other vehicle systems), a length of time between a time of submission of a shipping request and a time of shipping, whether the owner moves the first vehicle system or other vehicles according to a reoccurring schedule, or the like. The shipping score may be based on the representative requesting shipment of the cargo the first vehicle system is carrying. Optionally, the prioritization score of the first vehicle system may be based on other data or information related to the first vehicle system, the owner of the first vehicle system, the shipping requester of the first vehicle system, the cargo being transported, the owner of the cargo, or the like.

The controller of the first vehicle system may determine and/or receive a second prioritization score of a second vehicle system. The second vehicle system may be moving along the same route as the first vehicle system (e.g., in a direction opposite the first vehicle system such that the first and second vehicle systems are moving towards each other), or may be moving along another route that intersects with the route of the first vehicle system. The controller may determine the second prioritization score of the second vehicle system, may receive the second prioritization score of the second vehicle system from an off-board controller, from the second vehicle system, from a database onboard and/or off-board the first vehicle system, from another vehicle system, or the like. The controller may compare the prioritization score of the first vehicle system with the second prioritization score of the second vehicle system to determine a prioritization ranking, order, or the like, between the first vehicle system and the second vehicle system. The prioritization ranking or order may indicate which of the first or second vehicle systems has priority to move first, and which vehicle system is to move second. For example, the vehicle system to move second may need to change an operating setting (e.g., slow or stop movement, change a direction of movement, move to a different route, or the like) to allow the vehicle system with the greater priority to move first along the route.

The controller may automatically control movement of the first vehicle system based on the prioritization ranking. For example, the first prioritization score of the first vehicle system may be greater or larger than the second prioritization score of the second vehicle system, indicating that the first vehicle system has priority or has a rank that is higher or greater than a rank or priority of the second vehicle system. The first vehicle system may have priority to move before or ahead of the second vehicle system if the prioritization ranking indicates that the first prioritization score is greater than the second prioritization score. For example, the first vehicle system is given expediency over the second vehicle system when the first and second vehicle systems encounter each other. Alternatively, the second vehicle system may have priority to move before or ahead of the first vehicle system if the prioritization ranking indicates that the first prioritization score is less than or lower than the second prioritization score of the second vehicle system.

In one embodiment in which the first and second vehicle systems are moving along the same route in opposite directions towards each other, the second vehicle system may have to move off of the route and onto a different route to allow the first vehicle system to continue moving along the route based on the first prioritization score of the first vehicle system being greater than the second prioritization score. In another embodiment in which the first and second vehicle systems are moving along intersecting routes, the first vehicle system may need to slow or stop movement to allow the second vehicle system to pass or move through the intersection before the first vehicle system based on the second prioritization score of the second vehicle system being greater than the first prioritization score of the first vehicle system. In another embodiment, the prioritization ranking may indicate that the first prioritization score is greater than the second prioritization score, but the first vehicle system may decide or elect to allow the second vehicle system to move ahead of or before the first vehicle system. For example, the first and/or second vehicle systems may decide to reject or ignore the prioritization ranking based on deadlines of the first and/or second vehicle systems to reach target destinations, based on a negotiation or agreement between the first and second vehicle systems, based on travel requirements and/or restrictions dictated by the cargo being carried by the vehicle systems, or the like.

In one or more embodiments, the first vehicle system may be a rail vehicle, an automobile, a truck, a bus, a mining vehicle, a marine vessel, an aircraft (manned or unmanned, such as a drone), an agricultural vehicle, industrial equipment, or another off-highway vehicle. Suitable rail vehicles may include a locomotive, a switcher, a shunter, or the like. Optionally, the first vehicle system may be a marine vessel or aircraft and may be devoid wheels. For example, the first vehicle system may move along a waterway, in a flight path, or the like. In one embodiment, the first vehicle system is a single vehicle. In other embodiments, the first vehicle system may include two or more vehicles that may travel together. Group movement may be accomplished by vehicles being mechanically coupled together, or by being mechanically separate but logically or virtually coupled and communicating with each other to travel together, such as in a train, convoy, consist, group, swarm, platoon, fleet, or the like. At least one vehicle of the vehicle system may be a propulsion-generating vehicle, and optionally the vehicle system may include one or more non-propulsion generating vehicles.

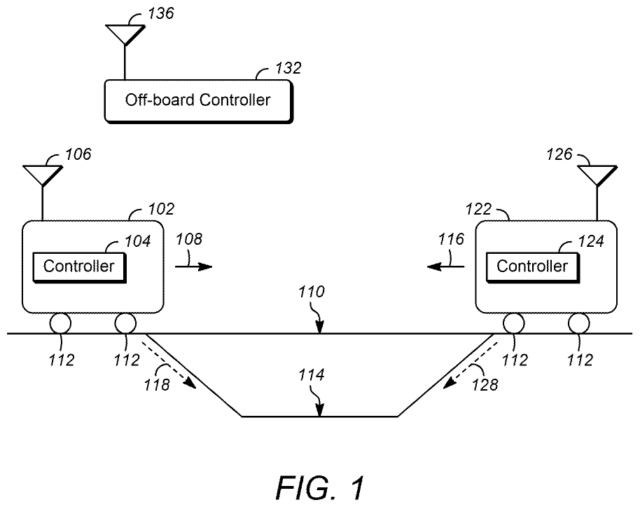

FIG. 1 illustrates one example of plural vehicle systems moving along a route 110 in accordance with one embodiment. A first vehicle system 102 moves along the route in a first direction 108, and a second vehicle system 122 moves along the same route in a second direction 116 that is opposite the first direction. For example, the first and second vehicle systems are moving towards each other along the same route. In the illustrated embodiment, the first vehicle system is a single vehicle and the second vehicle system is a single vehicle, but alternatively one or both of the first or second vehicle systems may include two or more vehicles that may travel together.

In the illustrated embodiment, the first and second vehicle systems are both vehicles that include wheels to move along the route. For example, the first and second vehicle systems each include wheels 112 in contact with the route. In one embodiment, the first and second vehicle systems may be the same type or kind of vehicle systems (e.g., automobiles, rail vehicles, mining vehicles, trucks, buses, or the like). In another embodiment, the first and second vehicle systems may be different kinds of vehicle systems that may move along the same route. For example, the first vehicle system may be a rail vehicle and the second vehicle system may be a high-rail vehicle that may move along a track or a paved route.

The first vehicle system includes a controller 104 disposed onboard the first vehicle system. The controller may represent a control module, and can include one or more processors, microcontrollers, or other logic-based devices and/or associated software or instructions, for carrying out one or more operations described herein. The controller controls operations of the first vehicle system, such as by controlling tractive efforts and/or braking efforts provided by a propulsion system and/or a braking system (not shown). The controller may be manually operated by receiving instruction signals from an input device (not shown) (e.g., a device that receives input from an operator such as, but not limited to, a touchscreen, a joystick, a keyboard, a switch, a wheel, a microphone, or the like) based on manually input from an operator at the input device. An output device (not shown) can provide information to the operator, such as a current first prioritization score of the first vehicle system, current operational settings of the first vehicle system, a topology report or map of the area in which the first vehicle system travels, a travel plan of the first vehicle system (e.g., that includes planned stops, target destination, routes along which the first vehicle system is to move to reach the planned stops and/or target destinations, characteristics or requirements of the cargo onboard the first vehicle system, or the like), or the like.

In one or more embodiments, the controller may be automatically operated to autonomously control operations of the first vehicle system. For example, a trip plan may be provided by an energy management system (not shown) and/or stored in a tangible and non-transitory computer readable storage medium, or memory (not shown), that is accessible by the controller. The controller and the energy management system may represent two or more control modules in one or more embodiments. The trip plan may designate operational settings of the vehicle system as a function of time or distance along the route for a trip of the vehicle system to a destination location. The designated operational settings of the trip plan may be established in order to reduce one or more of fuel consumed, emissions generated, or time spent in transit by the vehicle system for the trip. The energy management system may include one or more processors, microcontrollers, or other logic-based devices, and/or associated software or instructions, for carrying out one or more operations described herein.

The second vehicle system includes a controller 124 disposed onboard the second vehicle system. The controller of the second vehicle system may be the same as or similar to the controller of the first vehicle system. For example, the controller of the second vehicle system may automatically control one or more operating settings of the second vehicle system, or may control one or more systems (e.g., braking system, propulsion system, auxiliary systems, or the like) of the second vehicle system.

The controller of the first vehicle system may communicate with onboard and/or off-board components via a communication system 106. The communication system represents transceiving circuitry, one or more antennas, modems, or the like. In one or more embodiments, the communication system may receive and provide data signals to the controller of the first vehicle system, to one or more wayside devices, to one or more systems onboard another vehicle of the first vehicle system, to the second vehicle system, to another vehicle system, or the like. The second vehicle system includes a communication system 126 that may be the same as or similar to the communication system of the first vehicle system. In one embodiment, the first vehicle system may communicate wirelessly with the second vehicle system, the off-board controller, wayside devices, or the like, via the communication system of the first vehicle system. Optionally, the first vehicle system may communicate with other vehicles, the second vehicle system, an off-board controller, wayside devices, or the like, via conductive pathways such as wires, cables, buses, or the like.

In one or more embodiments, the first and/or second vehicle systems may be communicatively coupled with an off-board controller 132. The off-board controller may represent a back-office server or a dispatch center, such as of a positive vehicle control (PVC) system. A PVC system is a control system in which a vehicle is allowed to move, and/or is allowed to move outside a designated restricted manner (such as above a designated penalty speed limit), only responsive to receipt or continued receipt of one or more signals (e.g., received from off-board the vehicle system) that meet designated criteria, the signals have designated characteristics (e.g., a designated waveform and/or content) and/or are received at designated times (or according to other designated time criteria) and/or under designated conditions. This is opposed to ‘negative’ vehicle control systems where a vehicle system is allowed to move unless a signal (restricting movement) is received. The back-office server may be a vital or a non-vital system such that data stored, contained, maintained, communicated between, or the like, may be vital (e.g., protected) and/or non-vital (e.g., non-protected) data. Alternatively, the off-board control system represents another computerized system that communicates with vehicles and/or vehicle systems described herein.

In one embodiment, the first vehicle system may communicate (e.g., wirelessly communicate) with the second vehicle system via the off-board controller. For example, a communication system 136 of the off-board controller may wirelessly receive communication signals from the first vehicle system, and may wirelessly communicate the communication signals to the second vehicle system. In one embodiment, the off-board controller may change or alter the communication signals received from the first vehicle system before communicating the altered signals to the second vehicle system.

In the illustrated embodiment of FIG. 1, the first vehicle system moves along the route in the direction 108 and the second vehicle system moves along the same route in the direction 116 that is opposite the first direction. For example, the first and second vehicle systems are moving towards each other along the same route. In order to determine which of the first or second vehicle systems should proceed first, a prioritization score of the first vehicle system is compared with a prioritization score of the second vehicle system to determine a prioritization rank between the first and second vehicle systems.

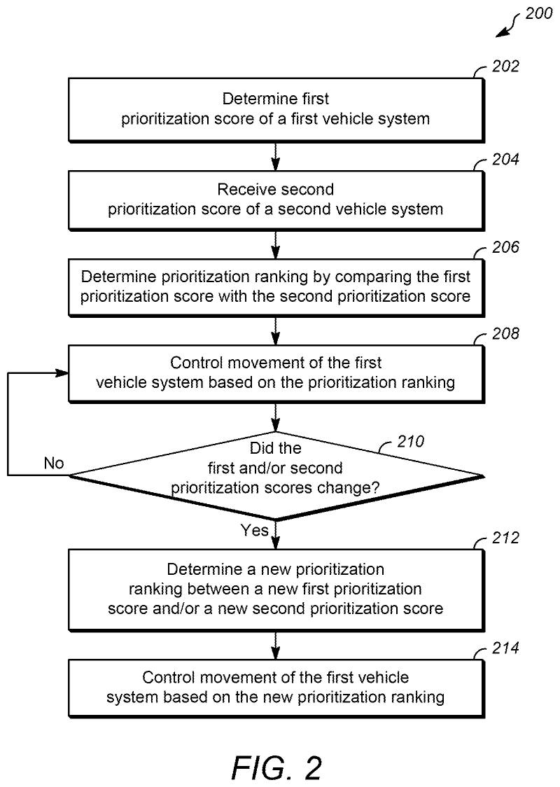

FIG. 2 illustrates a flowchart 200 of one example of controlling movement of a vehicle system based on a prioritization ranking of the vehicle system relative to a prioritization ranking of other vehicle systems. At step 202, the controller of the first vehicle system determines a first prioritization score of the first vehicle system. Optionally, the controller may receive from the first prioritization score of the first vehicle system from another vehicle system (e.g., a second vehicle system), from the off-board controller, from another accessible database, or the like. For example, the off-board controller or the second vehicle system may wirelessly communicate the first prioritization score to the controller of the first vehicle system. Optionally, the controller of the second vehicle system may determine a second prioritization score of the second vehicle system.

The first prioritization score may be indicative of one or more characteristics of the first vehicle system, and the second prioritization score may be indicative of one or more characteristics of the second vehicle system. The first prioritization score of the first vehicle system may be calculated or otherwise determined based on one or more of the first vehicle system (e.g., the asset), based on an owner of the first vehicle system (e.g., individual, organization, or the like), based on the cargo the first vehicle system is carrying or transporting (e.g., people, animals, goods, other products, or the like), based on a shipper of the cargo (e.g., an individual or organization that has requested shipment of the cargo, or the like), or the like.

The one or more characteristics of the first vehicle system used to determine the first prioritization score may include the asset (e.g., the vehicle), the owner of the first vehicle system, the owner of the cargo, the shipping requester, or the like. In one embodiment, the first prioritization score may include an asset score, an owner score, a shipper score, or the like. The asset score may be based on an asset of the first vehicle system such as the structure of the first vehicle system (e.g., the vehicle frame, wheels, other mechanical features or components, or the like), systems onboard the first vehicle system (e.g., a brake system, a propulsion system, auxiliary systems, communication system, global positioning system, a battery or other energy storage system, auxiliary systems, or the like), an age of the first vehicle system, a maintenance schedule of the first vehicle system, a time between the two sequential maintenance and/or repair operations, technology upgrades that have been made to the first vehicle system, a history of the vehicle system (e.g., history of repairs, history of trips made, history of failures or breakdowns, history of technological updates, or the like), or the like.

The owner score may be based on the owner of the vehicle system (e.g., an individual owner or organization) and one or more characteristics related to the owner. For example, the one or more characteristics may include historical behavior by the owner (e.g., short-notice shipping requests, vehicle breakdowns, scheduled and/or reoccurring shipments, offering other vehicles with a lower prioritization ranking to move before or ahead, or the like), or other citizen behaviors. In one or more embodiments, the owner score may be referred to as a citizen score that corresponds to the underlaying operating entity of the asset (e.g., the individual or company that owns and/or controls the vehicle system). The shipper score may be based on the shipper of the vehicle system. The shipper may be referred to as an individual or organization requesting to ship the product or cargo. The shipper score may be based on the shipper (e.g., the individual and/or organization), or one or more characteristics related to the shipper. For example, the characteristics may include historical behavior by the shipper (e.g., short-notice shipping requests, scheduled shipping requests, reoccurring shipping requests), a target destination where shipment is requested, historical target destinations, or the like. In one embodiment, the first prioritization score may be an average of two or more of the asset score, the owner score, or the shipper score of the first vehicle system. In one embodiment, the ratio between two or more of the scores may be 1:1, less than 1:1, or greater than 1:1. For example, one score may have a weight that is greater than or less than a weight of another score. For example, the ratio of the asset score to the owner score may be about 2:1, or the ratio of the owner score to the shipper score may be about 0.5:1. Optionally, the first prioritization score may be calculated by any other alternative mathematical concepts.

In one or more embodiments, the controller of the first vehicle system may have information stored within the computer readable storage medium or memory of the controller (e.g., onboard the first vehicle system) to determine the first prioritization score of the first vehicle system. Optionally, the controller may need to request and/or receive some information from a source off-board the first vehicle system that may be used to determine the first prioritization score (e.g., from the off-board controller, from another accessible database such as a maintenance or repair shop, or the like). Optionally, the controller may receive sensed data from sensors onboard the vehicle system (not shown) that may be used to determine the first prioritization score. For example, the sensed data may be associated with and/or indicate a state and/or performance level of the braking system, an exhaust system, one or more wheels and/or axles of the vehicle system, or the like.

At step 204, the controller of the first vehicle system receives the second prioritization score of the second vehicle system (e.g., from the controller of the second vehicle system, from the off-board controller, from an alternative shared database, or the like). For example, the controller of the first vehicle system may receive the second prioritization score of the second vehicle system from a wireless communication command message from the controller of the second vehicle system, the off-board controller, or the like. Optionally, the controller of the first vehicle system may determine the second prioritization score of the second vehicle system. In one or more embodiments, the controller of the second vehicle system may determine the second prioritization score of the second vehicle system, and may receive the first prioritization score of the first vehicle system (e.g., from the controller of the first vehicle system, from the off-board controller, from an alternative shared database, or the like). For example, the first vehicle system may wirelessly communicate the first prioritization score to the second vehicle system, and/or the second vehicle system may wirelessly communicate the second prioritization score to the first vehicle system. Optionally, the first and second vehicle systems may wirelessly communicate the first and second prioritization scores, respectively, with the off-board controller, with a database accessible by the controllers of the first and second vehicle systems, or the like.

In one or more embodiments, the first and second prioritization scores of the may correspond to or be referred to as credit scores that reflects historical performances of the underlying operating entity (e.g., a company or individual that owns and/or controls the vehicle systems), the actual vehicle system (e.g., the asset), the shipping requestor, etc. For example, like a credit score of an individual or entity, the prioritization score may reflect one or more historical factors of the first and second vehicle systems.

At step 206, one or both of the controllers of the first and/or second vehicle systems may determine a prioritization ranking between the first and second vehicle systems by comparing the first prioritization score with the second prioritization score. In one embodiment, the off-board controller may determine the prioritization ranking between the first and second vehicle systems based on the first and second prioritization scores, and may communicate the prioritization ranking to the first and second vehicle systems. The prioritization ranking indicates a rank, order, priority, or the like, between the first and second vehicle systems. The vehicle system that has the greater or higher prioritization score may be ranked higher than the other vehicle system in the prioritization ranking. For example, the first prioritization score of the first vehicle system may be 500, and the second prioritization score of the second vehicle system may be 450. The first vehicle system would be ranked or positioned higher than the second vehicle system in the prioritization ranking based on the first prioritization score being greater than the second prioritization score. In one embodiment, the prioritization scores may have accuracies up to 1 decimal place (e.g., 500.2), up to 5 decimals places (e.g., 500.21154), up to 10 decimal places (e.g., 500.2115433962), or the like.

The vehicle system that has the greater score or higher ranking may be allowed to travel before or ahead of the other vehicle system (e.g., without changing operations of the vehicle system), and the vehicle system with the lower score or lower ranking may be required to travel behind or after the vehicle system with the higher rank (e.g., by changing an operation such as to slow or stop movement, change a direction of movement, or the like). In one example, if the first prioritization score of the first vehicle system is greater than the second prioritization score of the second vehicle system, the controller of the first vehicle system and the controller of the second vehicle system may determine that the first vehicle system has priority to move before or ahead of the second vehicle system, and the second vehicle system has to wait for the first vehicle system to move, and the second vehicle system may move after the first vehicle system. As another example, if the first prioritization score of the first vehicle system is less than or lower than the second prioritization score of the second vehicle system, the second vehicle system has a priority rank that is greater than a priority rank of the first vehicle system. The controllers of the first and second vehicle systems may determine that the second vehicle system is allowed to move before or ahead of the first vehicle system, and the first vehicle system moves after the second vehicle system.

At step 208, the controller of the first vehicle system may automatically (e.g., without operator input, intervention, and/or control) control operation of the first vehicle system based on the prioritization ranking of the first vehicle system relative to the prioritization ranking of the second vehicle system. Additionally or alternatively, the controller of the second vehicle system may automatically control operation of the second vehicle system based on the prioritization ranking of the second vehicle system relative to the prioritization ranking of the first vehicle system.

Returning to FIG. 1, in one example, the first prioritization ranking of the first vehicle system may be greater than the second prioritization ranking of the second vehicle system indicating that the first vehicle system has priority to move ahead of or before the second vehicle system. The controller of the second vehicle system may automatically control operation of the second vehicle system to move in an alternative direction 128 away from the route 110 and toward an alternative route 114. Additionally, the controller of the first vehicle system may automatically control operation of the first vehicle system to continue moving along the route 110 (e.g., may maintain operating settings of the first vehicle system, may change one or more settings such as to speed up or slow down movement of the first vehicle system to move along the route, or the like). The second vehicle system may wait or stay positioned on the alternative route until the first vehicle system has moved past the second vehicle system along the route 110. Alternatively, if the first prioritization score of the first vehicle system is less than the second prioritization score of the second vehicle system, the controller of the first vehicle system may automatically control movement of the first vehicle system toward the alternative route in a direction 118, and the controller of the second vehicle system may control operation of the second vehicle system to continue moving along the route 110.

In one embodiment, the controller of the second vehicle system may control operation of the second vehicle system to return to the original route 110 subsequent to the first vehicle system moving past the second vehicle system along the route. In another embodiment, the second prioritization score may be less than a third prioritization score of a third vehicle system (not shown) moving along the same route 110. The second vehicle system may wait on the alternative route 114 until the third vehicle system has moved past the second vehicle system based on the second prioritization score of the second vehicle system being less than the third prioritization score of the third vehicle system.

Returning to FIG. 2, at step 210 a determination is made whether the first and/or second prioritization scores have changed. If at least one of the first or second prioritization scores have changed, flow of the method proceeds toward step 212. Alternatively, if none of the first or second prioritization scores have changed, flow of the method returns to 208 and the controllers of the first and second vehicle systems automatically control movement of the first and second vehicle systems, respectively.

In one embodiment, the first and/or second prioritization scores may have changed based on one or more changes to one or more characteristics of the asset of the first vehicle system, the owner of the first vehicle system, the shipper of the cargo. For example, the owner and/or the shipper may schedule reoccurring moves (e.g., travel along the route every week, every 3 weeks, every year, or the like). Scheduling the reoccurring moves may change the owner and/or shipper score, such as a reward to the owner and/or shipper for scheduling the reoccurring moves. As another example, the asset score may decrease based on the age and/or usage of the asset. For example, the asset (e.g., the vehicle) may age over time and with increased usage, and may be prone to failures and/or breakdowns of different systems onboard the vehicle system. Optionally, the asset score may change (e.g., be reduced) based on the life of the asset reaching a predetermined threshold, may change (e.g., be increased) based on the asset having technological updates made to systems onboard or scheduling regular maintenance intervals, or the like. As another example, the shipper score may change based on the type and/or amount of cargo being transported by the vehicle system. For example, the vehicle system may off-load some cargo and/or load some new or additional cargo at a loading/unloading location along the route. Changing the type, amount, or the like, of the cargo onboard the vehicle system may change the shipper score associated with the cargo being transported.

In one embodiment, the first and/or second prioritization scores may have changed based on an agreement between the first and second vehicle systems. The first prioritization score of the first vehicle system may be greater than the second prioritization score of the second vehicle system, but the second vehicle system may have an agreement with the first vehicle system to allow the second vehicle system to move ahead of or before the first vehicle system. For example, the first vehicle system may determine that it is ahead of schedule to reach a target destination, and the second vehicle system may determine that it is behind schedule to reach a target destination. The second vehicle system may request a favor with the first vehicle system to upgrade the second prioritization score so that it is greater than the first prioritization score to allow the second vehicle system to move ahead of or before the first vehicle system. Changing the prioritization scores based on an agreement changes the prioritization ranking between the first and second vehicle systems.

For example, the controller of the first vehicle system may determine that allowing the second vehicle system to travel first (e.g., have the greater or higher priority) would still enable the first vehicle system to reach the target destination no more than about 5% or about 10% behind schedule. In one embodiment, the first vehicle system may be rewarded for granting the favor to the second vehicle system. For example, the first prioritization score may increase responsive to the first vehicle system granting the favor to the second vehicle system. Additionally or alternatively, the second vehicle system may be penalized for needing to request the favor from the first vehicle system. For example, the second vehicle system may be penalized and the second prioritization score may be reduced based on the second vehicle system running behind schedule (e.g., disrupting other vehicles, delaying the delivery of the cargo, or the like).

In one or more embodiments, the first and/or second prioritization scores may change based on a financial transaction. For example, the first vehicle system may buy or purchase a score increase from an off-board controller, a central database that controls and/or coordinates prioritization scores and rankings, or the like. For example, the first vehicle system may require a ranking that is greater than the second vehicle system in order for the first vehicle system to move ahead of or before the second vehicle system, such as to ensure arrival at a target destination by an arrival deadline. The first vehicle system may submit payment to a bank, controlling system or organization, or the like, in exchange for an increase to the first prioritization score. The increase may be sufficient to change the prioritization ranking such that the first vehicle system may have a lower ranking than the second vehicle system before the purchase of the score increase, and that the first vehicle system may have a greater ranking than the second vehicle system after the purchase of the score increase. In one or more embodiments, the purchase of a score increase may temporarily benefit the first vehicle system (e.g., for the present or current trip the first vehicle system is taking), but may subsequently punish the first vehicle system. For example, after the first vehicle system purchases the score increase and reaches the target destination, the first prioritization score of the first vehicle system may be determined and/or calculated, and may be less than the first prioritization score before the purchase of the score increase.

In one or more embodiments, a new the prioritization score may be determined by the controllers of the first and/or second vehicle systems, and/or by the off-board controller, every time the vehicle systems stop moving (e.g., reaches a target location, reaches a final destination, or the like), at predetermined intervals of time (e.g., every 10 kilometers, every 100 kilometers, every 24 hours, every week, every month, or the like). Optionally, new prioritization scores may be determined responsive to a condition or characteristic of the vehicle system changing (e.g., additional vehicles are added to or separated from the first vehicle system, a maintenance schedule of the first vehicle system changes, the cargo being transported by the vehicle system changes, or the like), responsive to a geographic location of the first and second vehicle systems (e.g., entering or leaving an area of increased vehicle or pedestrian congestion, a proximity or distance away from intersections with intersecting routes, or the like), or the like.

At step 212, a new prioritization ranking is determined by comparing the new or original first prioritization score with the new or original second prioritization score. For example, a new prioritization ranking may be determined by comparing the original first prioritization ranking with a new second prioritization ranking, by comparing a new first prioritization ranking with the original second prioritization ranking, or by comparing the new first prioritization ranking with the new second prioritization ranking. The new prioritization ranking may indicate which of the first or second vehicle systems has a greater priority or a higher ranking relative to the other vehicle system, and indicate which of the first or second vehicle systems may be allowed to or have permission to move first ahead of or before the other vehicle system.

At step 214, the controllers of the first and second vehicle systems automatically (e.g., without operator intervention) control movement of the first and second vehicle systems, respectively, based on the new prioritization ranking between the first and second vehicle systems. In one example, the original first prioritization score of the first vehicle system may be greater than the original second prioritization score of the second vehicle system, and the controller of the first vehicle system may automatically control movement of the first vehicle system according to first operating conditions based on the prioritization ranking indicating the first vehicle system has a rank or priority that is higher than the second vehicle system. Alternatively, the new first prioritization score of the first vehicle system may be less than the original second prioritization score of the second vehicle system. The controller of the first vehicle system may automatically control movement of the first vehicle system according to different, second operating conditions based on the new prioritization ranking indicating that the second vehicle system has a rank or priority that is higher or greater than the first vehicle system.

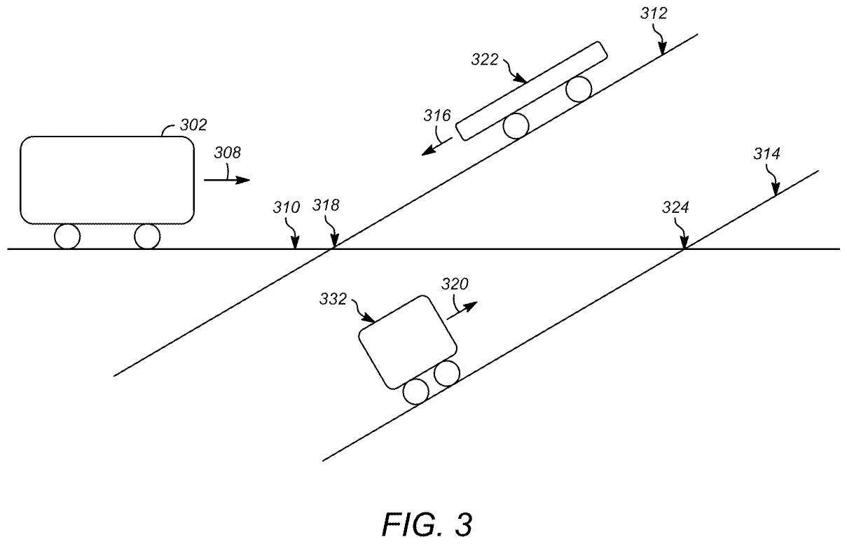

FIG. 3 illustrates one example of a prioritization system including plural vehicle systems moving along intersecting routes in accordance with one embodiment. In the illustrated embodiment, a first vehicle system 302 moves along a first route 310 in a first direction 308. The first route intersects with a second route 312 at a first intersection 318, and intersects with a third route 314 at a second intersection 324. A second vehicle system 322 moves along the second route in a second direction 316, and a third vehicle system 332 moves along the third route in a third direction 320. A controller of the first vehicle system (not shown) may determine a first prioritization score of the first vehicle system, a controller of the second vehicle system (not shown) may determine a second prioritization score of the second vehicle system, and a controller of the third vehicle system (not shown) may determine a third prioritization score of the third vehicle system. The controllers of each of the first, second, and third vehicle systems may receive the prioritization scores of the other vehicle systems to determine a prioritization ranking between the first, second, and third prioritization scores of the first, second, and third vehicle systems, respectively.

In one example, the first prioritization score may be greater than the second prioritization score. The controller of the second vehicle system may automatically change one or more operating settings of the second vehicle system to control movement of the second vehicle system based on the prioritization ranking. For example, the controller of the second vehicle system may slow or stop movement of the second vehicle system to stop before the second vehicle system enters the first intersection between the first and second routes to allow the first vehicle system to move through the first intersection before the second vehicle system moves through the first intersection.

Optionally, the third prioritization score of the third vehicle system may be greater than the first prioritization score of the first vehicle system. For example, the third vehicle may have a prioritization ranking that is greater or higher than the prioritization ranking of the first vehicle system. In one embodiment, the controller of the first vehicle system may automatically control movement of the first vehicle system to slow or stop prior to the first vehicle system reaching the second intersection between the first and third routes. For example, the controller of the first vehicle system may control movement of the first vehicle system to allow the third vehicle system to move or pass through the second intersection before the first vehicle system moves or passes through the second intersection.

In one or more embodiments, the prioritization ranking between the first, second, and third vehicle systems may be based on the type of vehicles and the routes along which the different types of vehicles move. For example, the first vehicle system may be a rail vehicle and may move along a track, and the second and third vehicle systems may be non-rail vehicles (e.g., automobiles, trucks, buses, or the like) and may move along a road. In one embodiment, the vehicle systems that move along the track (e.g., the first route) may be prioritized over the vehicle systems that move along the roads (e.g., the second and third routes). In another embodiment, the prioritization score of the first vehicle system that moves along the track may be modified (e.g., by a percentage, or the like) and the prioritization scores of the second and third vehicle systems may not be modified based on the first vehicle system moving along the track and the second and third vehicle systems not moving along the track. In another embodiment, the prioritization ranking between the first, second, and third vehicle systems may be ignored based on the type of routes along which each of the first, second, and third vehicle systems move. For example, the second prioritization score of the second vehicle system may be greater than the first prioritization score of the first vehicle system and the third prioritization score of the third vehicle system, but the ranking of the second vehicle system over the first vehicle system may be ignored based on the first vehicle system moving along the track and the second vehicle system not moving along a track.

In one or more embodiments, prioritization scores may be modified and/or ignored based on the type or classification of the vehicle system. For example, the first prioritization score may be less than or lower than the second prioritization score of the second vehicle, but the first vehicle system may be an emergency vehicle (e.g., firetruck, police vehicle, ambulance, or the like). The prioritization ranking between the first and second vehicle systems may be ignored, and priority may automatically be given to the first vehicle system based on the first vehicle system being an emergency vehicle. In one or more embodiments, the prioritization scores of vehicles and/or the prioritization ranking between different vehicles may be ignored and/or modified based on the other characteristics such as the time of day the vehicle systems are moving along the route(s) (e.g., during a time of increased vehicle congestion relative to other times of reduced vehicle congestion), the type of cargo being transported (e.g., defense materials, construction materials, livestock, ride-sharing passengers, or the like), or the like.

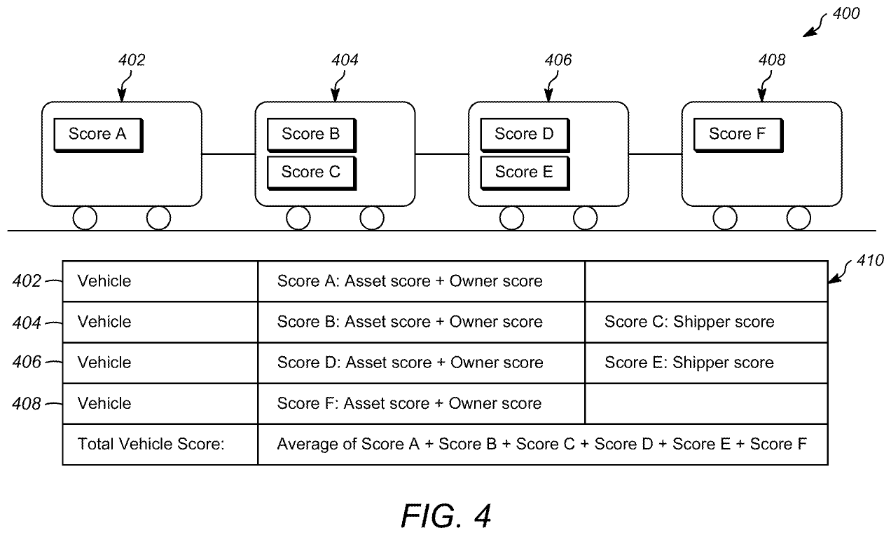

In one or more embodiments, a vehicle system may include two or more vehicles that travel together, and a prioritization score of the vehicle system may be based on each of the two or more vehicles that travel together. For example, FIG. 4 illustrates one example of determining a prioritization score of a vehicle system 400 in accordance with one embodiment. The vehicle system includes a first vehicle 402, a second vehicle 404, a third vehicle 406, and a fourth vehicle 408. The vehicles are coupled together (e.g., mechanically and/or logically) and may move along a route.

In one or more embodiments, a prioritization score of the vehicle system may be based on different prioritization scores of each of the different vehicles of the vehicle system. For example, a table 410 illustrates one example of different scores of the different vehicles that may be used to determine the overall prioritization score of the vehicle system. The first vehicle 402 may have a Score A (e.g., an asset score and an owner score of the first vehicle). The second vehicle 404 may have a Score B (e.g., an asset score and an owner score of the second vehicle) and a Score C (e.g., a shipper score). The third vehicle 406 may have a Score D (e.g., an asset score and an owner score of the third vehicle) and a Score E (e.g., a shipper score). The fourth vehicle 408 may have a Score F (e.g., an asset score and an owner score of the fourth vehicle). In one embodiment, the prioritization score of the vehicle system may be an average of the Scores A, B, C, D, E, and F. Optionally, other mathematical concepts (e.g., median, mean, or the like) may be used to determine the prioritization score of the vehicle system that includes plural different scores associated with the plural different vehicles.

In one or more embodiments, the vehicle system may be a single vehicle that moves along a route. For example, the single vehicle may be a rail vehicle, a non-rail vehicle (e.g., automobile, bus, truck, agricultural vehicle, mining vehicle, or the like), an aerial vehicle (manned or unmanned), a marine vessel, or the like. The prioritization score of the single vehicle system may be based on one or more of an owner score, an asset score, a shipper score, a cargo score, or the like. As one example, a single drone may have a prioritization score that remains static relative to a multi-vehicle vehicle system that has a prioritization score that changes based on vehicles being added or removed from the vehicle system. As another example, a passenger car may have one or more of an owner score, an asset score, and/or an occupant score (e.g., the passenger car is used for a ride-sharing service).

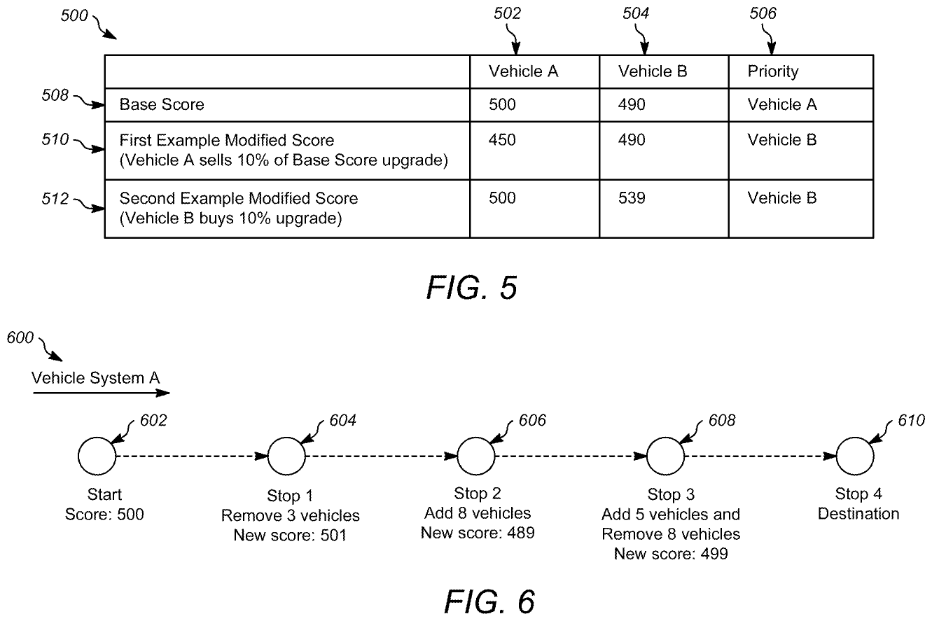

In one or more embodiments, the prioritization scores of vehicle systems, and a corresponding prioritization ranking between different vehicle systems may change. FIG. 5 illustrates one example of determining a prioritization ranking between different vehicle systems based on changes to the prioritization scores of the different vehicle systems in accordance with one embodiment. A table 500 includes a first column 502 directed to a vehicle A, a second column 504 directed to a vehicle B, and a third column 506 indicating a prioritization ranking between the vehicle A and vehicle B.

The table includes a first row 508 that indicates default or base prioritization scores of the vehicle A and vehicle B. The vehicle A may have a base prioritization score of 500, and the vehicle B may have a base prioritization score of 490. In one example, the base prioritization scores of the vehicles A and B may be the initial scores the vehicles A and B are determined to have at the start of travel of the vehicles A and B. For example, the base or default scores may be determined as a function of vehicle type and/or age, a planned route of the vehicle system, cargo, the owner or owning entity of the vehicle system (e.g., a citizen score), the shipping entity (e.g., a shipping requester score), or the like.

In the illustrated embodiment, the prioritization score 500 of the vehicle A is greater than the prioritization score 490 of the vehicle B, and therefore the vehicle A has a ranking or priority that is greater than a ranking or priority of the vehicle B (indicated in the third column). For example, vehicle A has a base, original, or default prioritization score that is greater than the base, original, or default score of the vehicle B. In one or more embodiments, the default scores of one or both of vehicle A and B may change based on changing values and/or conditions of the vehicle, the owner, or the like. For example, after a certain amount of time of travel, the default score of the vehicle A may decrease based on the age or life of the vehicle A increasing. As another example, the base score of the vehicle A may increase from one trip to another based on the owners score increasing (e.g., the owner may improve in scheduling planned shipments or travel of the vehicle A, the owner may perform maintenance on vehicle A more frequently, or the like).

In one or more embodiments, the prioritization scores of one or both of the vehicles A or B may change. The base prioritization scores of vehicles A and/or B may be modified or changed (e.g., in real time, on the fly, as the vehicles are moving, or the like) based on received data of various types (e.g., one or more characteristics of the vehicles changing, one or more requests by the vehicles, or the like). In one example shown in a second row 510, the vehicle A may sell about 10% of the base score of the vehicle A (e.g., to a prioritization banking system, to the off-board controller, to another vehicle system, or the like), and the prioritization score of the vehicle A may change from 500 to 450 based on the selling of the 10% of the base score. Selling the portion of the prioritization score of the vehicle A reduces the prioritization score of the vehicle A, and changes the prioritization ranking between the vehicle A and the vehicle B such that the prioritization score of the vehicle B is greater than the prioritization score of the vehicle A.

In one example, the vehicle A may elect or chose to sell a portion of the prioritization score of the vehicle A based on the vehicle A being ahead of a schedule to reach a target location (e.g., the vehicle A can slow or stop movement and may still reach the target location by the scheduled time of arrival because it is determined that the vehicle A is ahead of schedule). As another example, the vehicle A may elect or chose to sell a portion of the prioritization score to change a status of the vehicle A. For example, the owner score of the vehicle A may have be graded as a C level, and selling a portion of the score may improve the grade of the owner score of the Vehicle A to a grade B level.

In another example shown in a third row 512, the vehicle B may buy or purchase an upgrade (e.g., from the off-board controller, directly from the vehicle A, from a prioritization coordination system, or the like). For example, the vehicle B may buy or purchase a 10% upgrade to increase the base prioritization score of the vehicle B by 10%. Buying the 10% upgrade changes the prioritization score of the vehicle B from 490 to 539, and changes the prioritization ranking between the vehicle A and vehicle B relative to the prioritization ranking of the base prioritization scores of the vehicles A and B. In one example, the vehicle B may purchase the upgrade based on determining that the vehicle B will not reach a target destination by a target time of arrival (e.g., the vehicle B is behind schedule).

In one or more embodiments, the first prioritization score of the vehicle A may change based on a penalty to the vehicle A (e.g., the first vehicle system). The penalty may be based on a disruption to the route by the vehicle A, a disruption to other vehicle systems, a mechanical failure of the vehicle A, a length of time between the vehicle A requesting to move along the route and vehicle A actually moving along the route, or the like. For example, the vehicle A may experience a mechanical failure while the vehicle A moves along the route causing the vehicle A to disrupt the movement of other vehicles to move along the same route. In another example, the owner of the vehicle A may also own a vehicle C, and the vehicle C may have caused a disruption to the route and other vehicles moving along the route. The disruption caused by the vehicle C owned by the same owner as vehicle A may result in the prioritization score of the vehicle A changing based on a penalty to the owner of the vehicles A and C.

In one or more embodiments, the first prioritization score of the vehicle A may change based on a reward to the vehicle A. For example, the vehicle A may be rewarded for selling a portion of the base prioritization score (e.g., to a banking system, to another vehicle system, or the like). The owner score of the vehicle A may receive an upgrade responsive to vehicle A selling the portion of the prioritization score of the vehicle A to fulfill a favor to another vehicle system, or the like.

FIG. 6 illustrates one example of changing a prioritization score of a vehicle system A in accordance with one embodiment. The vehicle system may represent the first vehicle system shown in FIG. 1. In one example, the vehicle system A may be a system that includes two or more vehicles coupled together to move along the route in a consist or convoy. The vehicle system A may move in a direction 600 from a starting location 602 toward a destination location 610. Between the start and destination locations, the vehicle system A may stop at a first stop 604, a second stop 606, and a third stop 608. At the starting location, the controller of the vehicle system may determine the prioritization score of the vehicle system. For example, the prioritization score may be 500. A new prioritization score may be determined responsive to the vehicle system reaching the first stop. For example, at the first stop, three vehicles may be separated or dropped from the vehicle system, such that the vehicle system has less three vehicles moving from the first stop to the second stop. Changing the number of vehicles including in the vehicle system may change the prioritization score (e.g., changes the average score of all vehicles included in the vehicle system, changes the average age of the vehicles of the vehicle system, changes the type or amount of cargo being transported, or the like). For example, the new prioritization score of the vehicle system may increase from the original prioritization score of 500 to a new prioritization score of 501.

The vehicle system A moves from the first stop to the second stop. At the second stop, the vehicle system may add eight new vehicles to the vehicle system. Changing the number of vehicles included in the vehicle system changes the prioritization score of the vehicle system. For example, the eight new vehicles may have lower individual prioritization scores relative to the individual prioritization scores of the other vehicles included in the vehicle system. The lower individual prioritization scores may change (e.g., reduce) the average prioritization score of the vehicle system from 501 to about 489. The new prioritization score may change the prioritization ranking between the vehicle system A and other vehicle systems the vehicle system A may encounter (e.g., on the same route or intersecting routes).

The vehicle system moves from the second stop to the third stop. At the third stop, the vehicle system may add five new vehicles and may drop the eight vehicles that were picked up at the second stop. The five new vehicles may have individual prioritization scores that are greater than the individual prioritization scores of the eight vehicles picked up at the second stop and dropped at the third stop. The different individual prioritization scores may change the average prioritization score of the vehicle system from 489 to 499. For example, the prioritization score may change responsive to changes to the vehicle system.

In one embodiment, one or more of the controllers may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, one or more of the controllers may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

In one or more embodiments of the subject matter described herein, a method includes determining a first prioritization score of a first vehicle system moving along a first route. The first prioritization score indicates one or more characteristics of the first vehicle system. A second prioritization score of a second vehicle system moving along the first route or a second route that intersects the first route is received. The second prioritization score indicates one or more characteristics of the second vehicle system. A prioritization ranking is determined between the first vehicle system and the second vehicle system by comparing the first prioritization score of the first vehicle system with the second prioritization score of the second vehicle system. Movement of the first vehicle system is automatically controlled based on the prioritization ranking.

Optionally, the second vehicle system may be moving on the first route in a direction that is opposite a direction of movement of the first vehicle system.

Optionally, the first prioritization score of the first vehicle system may be changed based on a penalty of the first vehicle system. The penalty of the first vehicle system may be based on one or more of a disruption to the first route, a disruption to other vehicle systems, a mechanical failure of the first vehicle system, or a length of time between the first vehicle system requesting to move along the first route and the first vehicle system moving along the first route.

Optionally, the first prioritization score may be changed based on a reward of the first vehicle system.

Optionally, the first vehicle system may include plural vehicles traveling together along the first route. The first prioritization score of the first vehicle system may be determined by determining a score of each of the plural vehicles of the first vehicle system.

Optionally, the first prioritization score of the first vehicle system may include one or more of an asset score, an owner score, or a shipper score. The asset score may be based on an asset of the first vehicle system, the owner score may be based on an owner of the first vehicle system, and the shipper score may be based on a shipper of the cargo disposed onboard the first vehicle system.

Optionally, the first prioritization score may be an average of two or more of the asset score, the owner score, or the shipper score of the first vehicle system.

Optionally, the first prioritization score may change based on one or more characteristics of one or more of the asset of the first vehicle system, the owner of the first vehicle system, or the shipper of the cargo disposed onboard the first vehicle system.

Optionally, automatically controlling operation of the first vehicle system based on the prioritization ranking between the first prioritization score and the second prioritization score may include operating the first vehicle system without operator intervention.

Optionally, the first prioritization score of the first vehicle system may be changed to a new first prioritization score based on an agreement between the first vehicle system and the second vehicle system. Changing the first prioritization score of the first vehicle system changes the prioritization ranking between the first prioritization score and the second prioritization score to a second prioritization ranking between the new first prioritization score and the second prioritization score.

Optionally, movement of the first vehicle system may be automatically controlled based on the second prioritization ranking. The first vehicle system may move according to first operating conditions of the first vehicle system based on the prioritization ranking, and the first vehicle system may move according to different, second operating conditions of the first vehicle system based on the second prioritization ranking.

In one or more embodiments of the subject matter described herein, a controller of a first vehicle system configured to move along a first route includes one or more processors that determine a first prioritization score of the first vehicle system indicative of one or more characteristics of the first vehicle system. The processors receive a second prioritization score of a second vehicle system that moves along the first route or a second route that intersects the first route. The second prioritization score indicates one or more characteristics of the second vehicle system. The processors determine a prioritization ranking between the first vehicle system and the second vehicle system by comparing the first prioritization score of the first vehicle system with the second prioritization score of the second vehicle system. The processors automatically control movement of the first vehicle system based on the prioritization ranking.

Optionally, the second vehicle system may move on the first route in a direction that is opposite a direction of movement of the first vehicle system.

Optionally, the first vehicle system may include plural vehicles traveling together along the first route. The one or more processors may determine the first score by determining a prioritization score of each of the plural vehicles.

Optionally, the first prioritization score of the first vehicle system may include one or more of an asset score, an owner score, or a shipper score. The asset score may be based on an asset of the first vehicle system, the owner score may be based on an owner of the first vehicle system, and the shipper score may be based on a shipper of cargo disposed onboard the first vehicle system.

Optionally, the first prioritizations score may be an average of two or more of the asset score, the owner score, or the shipper score.

Optionally, the first prioritization score may change based on one or more characteristics of one or more of the asset of the first vehicle system, the owner of the first vehicle system, or the shipper of the cargo disposed onboard the first vehicle system.

Optionally, the processors may change the first prioritization score to a new first prioritization score based on an agreement between the first vehicle system and the second vehicle system. Changing the first prioritization score of the first vehicle system may change the prioritization ranking between the first prioritization score and the second prioritization score to a second prioritization ranking between the new first prioritization score and the second prioritization score.

Optionally, the processors may automatically control movement of the first vehicle system based on the second prioritization ranking. The first vehicle system may move according to first operating conditions of the first vehicle system based on the prioritization ranking, and the first vehicle system may move according to different, second operating conditions of the first vehicle system based on the second prioritization ranking.

In one or more embodiments of the subject matter described herein, a method includes determining a ranking between a first vehicle system and a second vehicle system by comparing a first prioritization score of a first vehicle system with a second prioritization score of a second vehicle system. The first vehicle system moves along a first route and the second vehicle system moves along the first route or a second route that intersects the first route. The first prioritization score of the first vehicle system is indicative of one or more characteristics of the first vehicle system, and the second prioritization score of the second vehicle system is indicative of one or more characteristics of the second vehicle system. The ranking indicates a priority of the first vehicle system that is greater than a priority of the second vehicle system. Movement of the first vehicle system is automatically controlled based on the ranking.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and clauses, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and clauses, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The clauses define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
determining a first prioritization score of a first vehicle system moving along a first route, the first prioritization score indicative of one or more characteristics of the first vehicle system;
receiving a second prioritization score of a second vehicle system moving along the first route or a second route that intersects the first route, the second prioritization score indicative of one or more characteristics of the second vehicle system;
determining a prioritization ranking between the first vehicle system and the second vehicle system based at least in part on a comparison of the first prioritization score of the first vehicle system with the second prioritization score of the second vehicle system; and
automatically controlling movement of the first vehicle system based on the prioritization ranking.

2. The method of claim 1, wherein the second vehicle system is moving on the first route in a direction that is opposite a direction of movement of the first vehicle system.

3. The method of claim 1, further comprising changing the first prioritization score of the first vehicle system based on a penalty of the first vehicle system, the penalty of the first vehicle system based on one or more of a disruption to the first route, a disruption to other vehicle systems, a mechanical failure of the first vehicle system, or a length of time between the first vehicle system requesting to move along the first route and the first vehicle system moving along the first route.

4. The method of claim 1, further comprising changing the first prioritization score of the first vehicle system based on a reward of the first vehicle system.

5. The method of claim 1, wherein the first vehicle system includes plural vehicles traveling together along the first route, and wherein the first prioritization score of the first vehicle system is determined by determining a score of each of the plural vehicles of the first vehicle system.

6. The method of claim 1, wherein the first prioritization score of the first vehicle system includes one or more of an asset score, an owner score, or a shipper score, the asset score based on an asset of the first vehicle system, the owner score based on an owner of the first vehicle system, and the shipper score based on a shipper of cargo disposed onboard the first vehicle system.

7. The method of claim 6, wherein the first prioritization score is an average of two or more of the asset score, the owner score, or the shipper score of the first vehicle system.

8. The method of claim 6, wherein the first prioritization score is configured to change based on one or more characteristics of one or more of the asset of the first vehicle system, the owner of the first vehicle system, or the shipper of the cargo disposed onboard the first vehicle system.

9. The method of claim 1, wherein automatically controlling operation the first vehicle system based on the prioritization ranking between the first prioritization score and the second prioritization score includes operating the first vehicle system without operator intervention.

10. The method of claim 1, further comprising changing the first prioritization score of the first vehicle system to a new first prioritization score based on an agreement between the first vehicle system and the second vehicle system, wherein changing the first prioritization score of the first vehicle system changes the prioritization ranking between the first prioritization score and the second prioritization score to a second prioritization ranking between the new first prioritization score and the second prioritization score.

11. The method of claim 10, further comprising automatically controlling movement of the first vehicle system based on the second prioritization ranking, wherein the first vehicle system is configured to move according to first operating conditions of the first vehicle system based on the priorization ranking, and the first vehicle system is configured to move according to different, second operating conditions of the first vehicle system based on the second prioritization ranking.

12. A controller of a first vehicle system configured to move along a first route, the controller comprising:
one or more processors configured to determine or receive a first prioritization score of the first vehicle system indicative of one or more characteristics of the first vehicle system,
the one or more processors configured to determine or receive a second prioritization score of a second vehicle system configured to move along the first route or a second route that intersects the first route, the second prioritization score indicative of one or more characteristics of the second vehicle system,
the one or more processors configured to determine a prioritization ranking between the first vehicle system and the second vehicle system based at least in part on a comparison of the first prioritization score of the first vehicle system with the second prioritization score of the second vehicle system, and
the one or more processors configured to automatically control movement of the first vehicle system based on the prioritization ranking.

13. The controller of claim 12, wherein the second vehicle system is configured to move on the first route in a direction that is opposite a direction of movement of the first vehicle system.

14. The controller of claim 12, wherein the first vehicle system comprises plural vehicles traveling together along the first route, wherein the one or more processors are configured to determine the first score by determining a prioritization score of each of the plural vehicles.

15. The controller of claim 12, wherein the first prioritization score of the first vehicle system includes one or more of an asset score, an owner score, or a shipper score, the asset score based on an asset of the first vehicle system, the owner score based on an owner of the first vehicle system, and the shipper score based on a shipper of cargo disposed onboard the first vehicle system.

16. The controller of claim 15, wherein the first prioritization score is an average of two or more of the asset score, the owner score, or the shipper score of the first vehicle system.

17. The controller of claim 15, wherein the first prioritization score is configured to change based on one or more characteristics of one or more of the asset of the first vehicle system, the owner of the first vehicle system, or the shipper of the cargo disposed onboard the first vehicle system.

18. The controller of claim 12, wherein the one or more processors are configured to change the first prioritization score to a new first prioritization score based on an agreement between the first vehicle system and the second vehicle system, wherein changing the first prioritization score of the first vehicle system changes the prioritization ranking between the first prioritization score and the second prioritization score to a second prioritization ranking between the new first prioritization score and the second prioritization score.

19. The controller of claim 18, wherein the one or more processors are configured to automatically control movement of the first vehicle system based on the second prioritization ranking, wherein the first vehicle system is configured to move according to first operating conditions of the first vehicle system based on the prioritization ranking, and the first vehicle system is configured to move according to different, second operating conditions of the first vehicle system based on the second prioritization ranking.

20. A method comprising:
determining a ranking between a first vehicle system and a second vehicle system based at least in part on a comparison of a first prioritization score of a first vehicle system with a second prioritization score of a second vehicle system, the first vehicle system moving along a first route, and the second vehicle system moving along the first route or a second route that intersects the first route, the first prioritization score of the first vehicle system indicative of one or more characteristics of the first vehicle system, the second prioritization score of the second vehicle system indicative of one or more characteristics of the second vehicle system, the ranking indicating a priority of the first vehicle system that is greater than a priority of the second vehicle system; and
automatically controlling movement of the first vehicle system based on the ranking.
